(19) United States
(12) Patent Application Publication
(10) Pub. No.: US 2016/0147299 A1
(43) Pub. Date: May 26, 2016

(54) APPARATUS AND METHOD FOR DISPLAYING IMAGE OF HEAD UP DISPLAY

(71) Applicant: HYUNDAI MOTOR COMPANY, Seoul (KR)

(72) Inventor: Cheol Han KIM, Yongin-si (KR)

(21) Appl. No.: 14/827,017

(22) Filed: Aug. 14, 2015

(30) Foreign Application Priority Data
Nov. 24, 2014 (KR) 10-2014-0164376

(51) Int. Cl. G06F 3/01; B60K 35/00; G02B 27/01

(52) U.S. Cl. CPC G06F 3/013; G02B 27/0179; B60K 35/00; G02B 2027/0181; B60K 2350/901; B60K 2350/965

(57) ABSTRACT

The present disclosure relates to an apparatus and a method for displaying an image of a head up display. The apparatus for displaying an image of a head up display includes: a sensor module configured to confirm angles of side mirrors installed on the left and right of a vehicle; a control module configured to estimate positions of driver's eyes based on the angles of the left and right side mirrors and set display positions of image data based on the estimated positions of driver's eyes; and an output module configured to display the image data at the set display positions so that the image data are displayed by being reflected from the windshield of the vehicle.

### CROSS-REFERENCE TO RELATED APPLICATION

This application is based on and claims the benefit of priority to Korean Patent Application No. 10-2014-0164376, filed on Nov. 24, 2014 in the Korean Intellectual Property Office, the disclosure of which is incorporated herein in its entirety by reference.

### TECHNICAL FIELD

The present disclosure relates to an apparatus and a method for displaying an image of a head up display, and more particularly, to an apparatus and a method for displaying an image of a head up display capable of confirming a driver's view position and set positions where image data of the head up display are displayed using the confirmed driver's view position.

### BACKGROUND

Recently, a head up display system which displays various pieces of vehicle information on a front glass window (hereinafter, referred to as a windshield) of a driver's seat of a vehicle as virtual image data to confirm information of the vehicle while allowing a driver to steadily keeping his/her eyes forward has been developed and equipped in the vehicle.

However, since the existing head up display system fixedly projects image data, which are projected on a front glass window of a driver's seat, to a preset specific position and displays the projected image data, when a driver is changed, there is inconvenience to newly set positions where image data of the head up display system are displayed due to different body conditions, driving postures, and the like for each driver.

### SUMMARY

The present disclosure has been made to solve the above-mentioned problems occurring in the prior art while advantages achieved by the prior art are maintained intact.

An aspect of the present disclosure provides an apparatus and a method for displaying an image of a head up display capable of estimating positions of driver's eyes based on angles of side mirrors which are installed on the left and right of a vehicle and setting positions of image data displayed on a windshield of the vehicle using the estimated positions of driver's eyes.

According to an exemplary embodiment of the present disclosure, an apparatus for displaying an image of a head up display includes: a sensor module configured to confirm angles of side mirrors which are installed on the left and right of a vehicle; a control module configured to estimate positions of driver's eyes based on the angles of the left and right side mirrors and set display positions of image data based on the estimated positions of driver's eyes; and an output module configured to display the image data at the set display positions so that the image data are displayed by being reflected from the windshield of the vehicle.

The control module may estimate the positions of driver's eyes based on up and down and left and right angles of the left and right side mirrors.

The control module may use left and right rotating angles of the left and right side mirrors to calculate a vertical distance from one virtual straight line which connects between central points of the left and right side mirrors to the positions of driver's eyes.

The control module may use up and down rotating angles of the left and right side mirrors to calculate a vertical distance from central points of the left and right side mirrors to a height of the driver's eyes.

The apparatus may further include: a memory configured to store a distance between the side mirrors which are installed on the left and right of the vehicle.

A distance between the side mirrors which are installed on the left and right of the vehicle may be a summed distance of a distance from the central points of the left side mirror to the positions of driver's eyes and a distance from the central point of the right side mirror to the positions of driver's eyes.

According to another exemplary embodiment of the present disclosure, a method for displaying an image of a head up display includes: confirming whether a driver boards a vehicle; confirming angles of side mirrors which are installed on the left and right of the vehicle if it is confirmed that the driver boards the vehicle; estimating the positions of driver' eyes based on the angles of the left and right side mirrors; setting display positions of image data based on the estimated positions of driver's eyes; and outputting the image data at the set output positions.

In the estimating of the positions of driver's eyes, the positions of driver's eyes may be estimated based on up and down and left and right angles of the left and right side mirrors.

The estimating of the positions of driver's eyes may include: generating one virtual straight line which connects between central lines of the left and right side mirrors; and calculating a vertical distance from the generated one virtual straight line to the positions of driver's eyes by using left and right rotating angles of the left and right side mirrors.

The estimating of the positions of driver's eyes may include: calculating a vertical distance from central points of the left and right side mirrors to a height of the driver's eyes by using up and down rotating angles of the left and right side mirrors.

### BRIEF DESCRIPTION OF THE DRAWINGS

The above and other objects, features and advantages of the present disclosure will be more apparent from the following detailed description taken in conjunction with the accompanying drawings.

FIG. 1 is a diagram illustrating main components of an apparatus for displaying an image according to an exemplary embodiment of the present disclosure;

FIG. 2 is a diagram for describing a method for confirming positions of eyes on an X-Y plane according to an exemplary embodiment of the present disclosure;

FIG. 3 is a diagram for describing a method for confirming positions of eyes on a Y-Z plane according to an exemplary embodiment of the present disclosure;

FIG. 4 is a diagram for describing a method for setting display positions of image data of a head up display on an X-Y plane according to an exemplary embodiment of the present disclosure;

FIG. 5 is a diagram for describing a method for setting display positions of image data of a head up display on a Y-Z plane according to an exemplary embodiment of the present disclosure; and

FIG. 6 is a flowchart for describing a method for displaying an image according to an exemplary embodiment of the present disclosure.

### DETAILED DESCRIPTION

Hereinafter, various exemplary embodiments of the present disclosure will be described with reference to the accompanying drawings. The exemplary embodiments of the present disclosure may be variously changed and variously practiced, but specific exemplary embodiments are illustrated in the accompanying drawings and detailed contents thereof will be described. However, it is to be understood that various exemplary embodiments of the present disclosure are not limited to the specific exemplary embodiments, but includes all modifications, equivalents, and substitutions included in the spirit and the scope of the present disclosure. In describing the drawings, like components are denoted by like reference numerals.

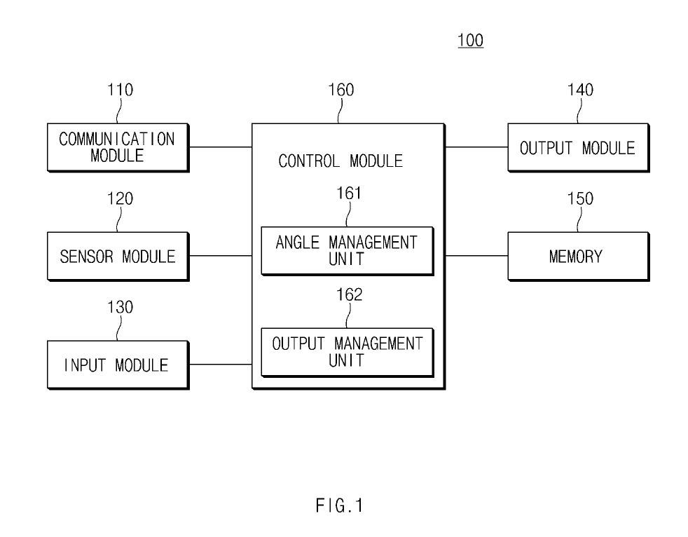

FIG. 1 is a diagram illustrating main components of an apparatus for displaying an image according to an exemplary embodiment of the present disclosure.

Referring to FIG. 1, an apparatus 100 for displaying an image according to an exemplary embodiment of the present disclosure may include a communication module 110, a sensor module 120, an input module 130, an output module 140, a memory 150, and a control module 160.

The communication module 110 may perform various intra-vehicle communications such as a controller area network (CAN), a CAN with flexible data rate (CAN-FD), FlexRay, a media oriented systems transport (MOST), and a time triggered Ethernet (TT Ethernet) for communication among the sensor module 120, the input module 130, the output module 140, the memory 150, and the control module 150.

The sensor module 120 may include sensors such as a pressure sensor and a weight sensor to confirm whether a driver boards a driver's seat among seats of a vehicle. The sensor module 120 may provide sensing information sensed by at least one sensor to the control module 160. Alternately, although not shown in FIG. 1, the sensor module 120 may provide the sensing information sensed by the at least one sensor to the control module 160 through the communication module 110.

The input module 130 may generate a control signal depending on an input from the outside. To this end, the input module 130 may be formed as input devices such as a keypad, a touch pad, and a touch screen and when the input module 130 is formed as a touch screen, the input module 130 may also serve as the output module 140.

The output module 140 is a head up display and may display image data for driving information of the vehicle by a control of the control module 160. The image data displayed from the output module 140 are reflected from the windshield and thus may be confirmed by a user. For this purpose, the output module 140 may be formed as output devices such as a thin film transistor liquid crystal display (TFT LCD) and a touch screen.

The memory 150 may store programs, and the like for operating the apparatus 100 for displaying an image. In particular, the memory 150 may store a distance between central points of side mirrors which are installed on the left and right of a vehicle. The memory 150 may store an algorithm for estimating positions of driver's eyes based on up and down and left and right rotating angles of the left and right side mirrors. The memory 150 may store an algorithm for calculating display positions of the image data based on the estimated positions of driver's eyes.

The control module 160 may estimate the positions of driver's eyes based on the angles of the left and right side mirrors and set the display positions of the image data based on the estimated positions of driver's eyes. For this purpose, the control module 160 may include an angle management unit 161 and an output management unit 162.

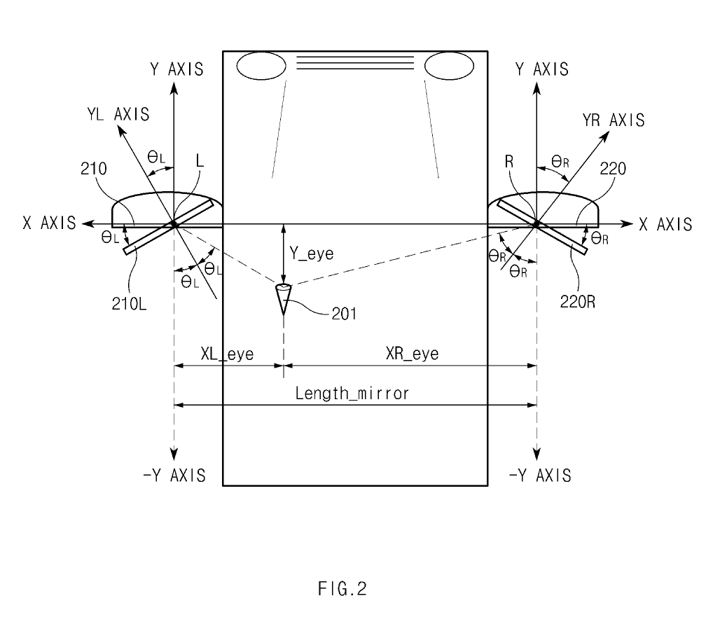

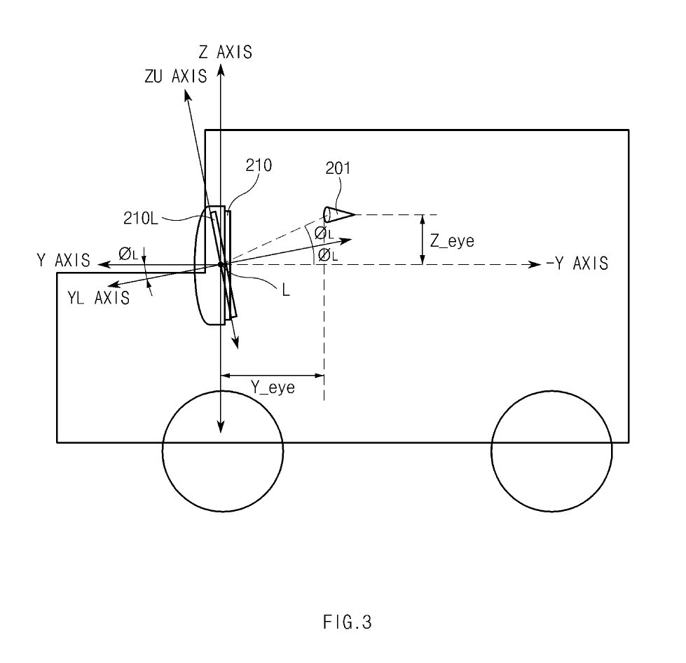

The angle management unit 161 may estimate the positions of driver's eyes based on up and down and left and right rotating angles of the left and right side mirrors. FIG. 2 is a diagram for describing a method for confirming positions of eyes on an X-Y plane according to an exemplary embodiment of the present disclosure. FIG. 3 is a diagram for describing a method for confirming positions of eyes on a Y-Z plane according to an exemplary embodiment of the present disclosure.

Referring to FIG. 2, the angle management unit 161 may assume side mirrors 210 and 220, which are installed on the left and right of the vehicle, as a plane and assume a single virtual straight line, which connects between central points L and R of the side mirrors 210 and 220, as an X axis. The angle management unit 161 may generate a virtual line vertical to the assumed X axis based on the central points L and R of the side mirrors 210 and 220 and assume the virtual line as a Y axis. The angle management unit 161 may assume the driver's eye as one point 201 and may assume that the driver keeps his/her eyes on a rear surface of the vehicle, for example, a-Y axis through the side mirrors 210 and 220.

According to the exemplary embodiment of the present disclosure, the angle management unit 161 may rotate a coordinate system (Y axis) of the left side mirror as much as θ_{L}, when the left side mirror 210 rotates left and right as much as θ_{L} and becomes a position of 210L, thereby generating a mirror coordinate system (YL axis). The Y axis rotates as much as a YL axis and thus an angle with respect to the −Y axis may be the θ_{L}, and an incident angle and a reflection angle formed based on a specific point and the −Y axis are equal to each other and thus the incident angle and the reflection angle may each be the θ_{L}.

According to the exemplary embodiment of the present disclosure, the angle management unit 161 may let the right side mirror 220 rotate left and right as much as θ_{R} and also rotates a coordinate system (Y axis) of the right side mirror as much as the θ_{R} when the right side mirror 220 rotates at 220R, thereby generating a mirror coordinate system (YR axis). The Y axis rotates as much as a YR axis and thus an angle with respect to the −Y axis may be the θ_{R}, and an incident angle and a reflection angle formed based on a specific point and the −Y axis are equal to each other and thus the incident angle and the reflection angle may each be the θ_{R}.

The angle management unit 161 may estimate an intersection point between a line forming an angle of the incident angle θ_{L} based on the −Y axis and a line forming an angle of the incident angle θ_{R} based on the −Y axis as a position 201 of a driver' s eye on an X-Y axis. In this case, since a distance length mirror between each central points L and R of the left side mirror 210 and the right side mirror 220, respectively, is pre-stored in the memory 150, the angle management unit 161 may estimate coordinates for the position 201 of a driver's eye on the X-Y plane based on the following Equations 1 to 3.

tan(90−2^{θ}L)=Y_eye/XL_eye [Equation 1]

tan(90−2^{θ}₂)=Y_eye/XR_eye [Equation 2]

Length_mirror=XL_eye+XR_eye [Equation 3]

Referring to FIG. 3, the angle management unit 161 may rotate a reference coordinate system (Z axis) of the side mirrors as much as Φ_{L}, when the side mirror 210 rotates up and down as much as the Φ_{L}, and thus is at a position of 210L, thereby generating the ZU axis. In this case, both of the side mirrors may be operated, but for convenience of explanation, in the exemplary embodiment of the present disclosure, the left side mirror will be described. The Y axis rotates as much as a YL axis and thus an angle with respect to the −Y axis may be the Φ_{L}, and an incident angle and a reflection angle formed based on a specific point and the −Y axis are equal to each other and thus the incident angle and the reflection angle may each be the Φ_{L}.

The angle management unit 161 may estimate the position 201 of a driver's eye based on the following Equation 4. In this case, as a Y eye, one calculated based on the following Equations 1 to 3 may be used.

tan(2^{Φ}_{L})=Z_eye/Y_eye [Equation 4]

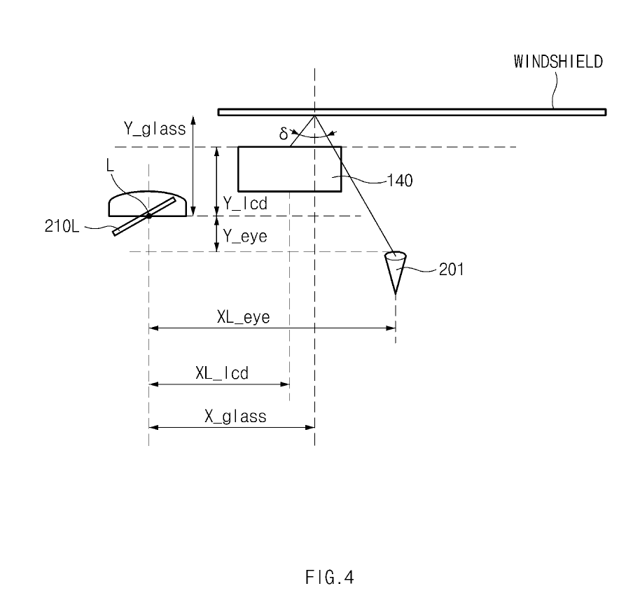

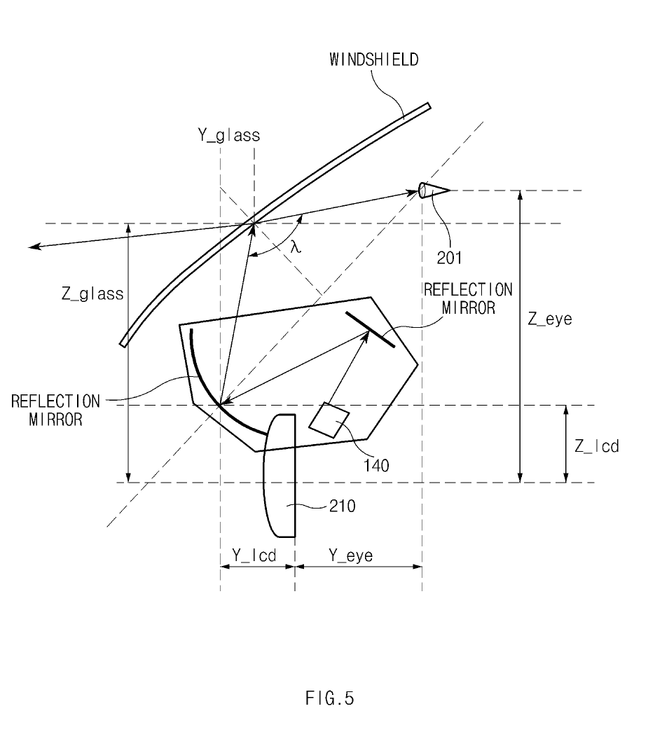

The output management unit 162 may set a position where the image data of the head up display are displayed based on the positions of driver's eyes estimated by the angle management unit 161. FIG. 4 is a diagram for describing a method for setting display positions of image data of a head up display on an X-Y plane according to an exemplary embodiment of the present disclosure. FIG. 5 is a diagram for describing a method for setting display positions of image data of a head up display on a Y-Z plane according to an exemplary embodiment of the present disclosure.

Definitions of variables illustrated in FIGS. 4 and 5 each are as follows. XL_lcd may mean an X-axis position of a reflection mirror (not illustrated), from which the image data output from the output module 140 is reflected, based on the left side mirror 210, Y_lcd may mean a Y-axis position of the reflection mirror based on the left side mirror 210, Z_lcd may mean a Z-axis position of the reflection mirror based on the left side mirror 210, X_glass may mean an X-axis distance up to a reflecting point of the windshield based on the left side mirror 210, Y_glass may mean a Y-axis distance up to the reflecting point of the windshield based on the left side mirror 210, Z_glass may mean a Z-axis distance up to the reflecting point of the windshield based on the left side mirror 210, δ may mean an angle formed by the reflection mirror and the windshield on the X-Y plane and the driver's eyes 201, and λ may mean an angle formed by the reflection mirror and the windshield on the Y-Z plane and the driver's eyes 201. In this case, when the reflection mirror illustrated in FIG. 5, the output module 140, and the positions of driver's eyes are changed, a sign is changed depending on the position and thus the display positions of the image data may be set. Further, it may be assumed that a reflection surface of the windshield of the reflection mirror is a plane and the windshield on the X-Y plane is parallel with the X-axis illustrated in FIG. 2.

Since an angle to drive the output module 140 may be an angle to make the reflection angle be δ/2 on the left and right and λ/2 at the upper and lower, the output management unit 162 may calculate δ and λ and may calculate the display positions of the image data in consideration of a mounting angle of the output module 140. The output management unit 162 may calculate the display positions of the image data based on the positions of driver's eyes using the following Equations 5 to 8.

tan (δ/2)=(X_glass−Y_glass)/(Y_glass−Y_lcd) [Equation 5]

tan (δ/2)=(XL_eye−X_glass)/(Y_eye+Y_glass) [Equation 6]

sin (λ/2)=[{(Y_lcd+Y_eye)²(Z_eye−Z_lcd)2}^{1/2}/2]/[{(Z_glass−Z_lcd)²+(Y_lcd−Y_glass)²}^{1/2}] [Equation 7]

sin (λ/2)=[{(Y_lcd+Y_eye)²(Z_eye−Z_lcd)²}^{1/2}/2]/[{(Z_glass−Z_lcd)²+(Y_lcd+Y_eye−Y_glass)²}^{1/2}] [Equation 8]

The output management unit 162 may control the output module 140 to display the image data at the display positions of the image data calculated based on the above Equations 5 to 8. The exemplary embodiment of the present disclosure describes an example in which the sensor module 120 and the memory 150 both are include in the apparatus 100 for displaying an image, but is not limited thereto. The sensor module 120 and the memory 150 may be included in external apparatuses such as navigation installed in a vehicle and the apparatus 100 for displaying an image may receive information required through communication with the external apparatuses.

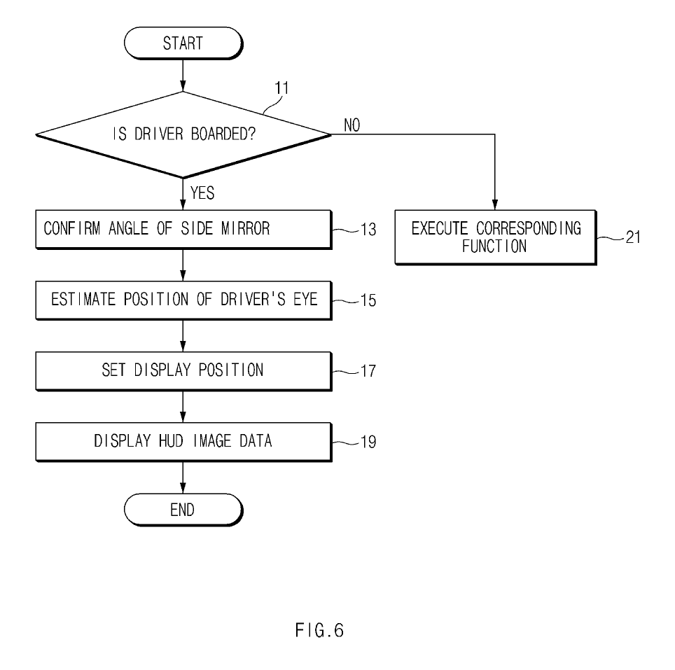

FIG. 6 is a flowchart for describing a method for displaying an image according to an exemplary embodiment of the present disclosure.

Referring to FIGS. 1 to 6, step 11, the control module 160 may confirm whether a driver boards a vehicle. When the control module 160 senses that the driver is seated on the driver's seat using various sensors such as a pressure sensor and a weight sensor which are installed at the driver's seat, the control module 160 confirms that the driver boards the driver's seat to execute step 13. In this case, when the angle of the side mirror is controlled, the control module 160 may confirm that the driver boards the driver's seat. If it is not confirmed that the driver is seated on the driver's seat in step 11, the control module 160 may execute step 21. In step 21, the control module 160 may execute the corresponding function such as manually setting the display positions of the image data of the head up display.

In step 13, the control module 160 may confirm the angle of the side mirror which is adjusted by the operation of the driver. In this case, the side mirrors may be installed on the left and right of the vehicle and the up and down and left and right angles of the side mirrors may be adjusted by the operation of the input module 130 by the driver.

In step 15, the control module 160 may estimate the positions of driver's eyes using the angles of the left and right side mirrors which are confirmed in step 13. This is already described using the above Equations 1 and 4 and therefore the detailed description thereof will be omitted.

In step 17, the control module 160 may set the display positions where the image data are displayed based on the estimated positions of driver's eyes. This is already described using the above Equations 5 to 8 and therefore the detailed description thereof will be omitted. In step 19, the control module 160 may display the image data at the set display positions to control the display of the image data of the head up display in consideration of the positions of driver's eyes.

As described above, according to the apparatus and the method for displaying an image of a head up display in accordance with the exemplary embodiments of the present disclosure, it is possible to estimate the positions of driver's eyes based on the angles of the side mirrors which are installed on the left and right of a vehicle and set the positions of image data displayed on the windshield of the vehicle using the estimated positions of driver's eyes.

The exemplary embodiments of the present disclosure disclosed in the present specification and the accompanying drawings have been provided only as specific examples in order to assist in understanding the present disclosure and do not limit the scope of the present disclosure. Therefore, it is to be understood that in addition to the exemplary embodiments of the present disclosure described herein, all the changed or modified forms derived from the technical spirit of the present disclosure are included in the scope of the present disclosure.

What is claimed is:

1. An apparatus for displaying an image of a head up display, comprising:
a sensor module configured to confirm angles of side mirrors installed on the left and right of a vehicle;
a control module configured to estimate positions of driver's eyes based on the angles of the left and right side mirrors and set display positions of image data based on the estimated positions of driver's eyes; and
an output module configured to display the image data at the set display positions so that the image data are displayed by being reflected from a windshield of the vehicle.

2. The apparatus according to claim 1, wherein the control module estimates the positions of driver's eyes based on up and down and left and right angles of the left and right side mirrors.

3. The apparatus according to claim 2, wherein the control module, based on left and right rotating angles of the left and right side mirrors, calculates a vertical distance from one virtual straight line which connects between central points of the left and right side mirrors to the positions of driver's eyes.

4. The apparatus according to claim 2, wherein the control module, based on up and down rotating angles of the left and right side mirrors, calculates a vertical distance from central points of the left and right side mirrors to a height of the driver's eyes.

5. The apparatus according to claim 3, further comprising:
a memory configured to store a distance between the side mirrors installed on the left and right of the vehicle.

6. The apparatus according to claim 5, wherein a distance between the side mirrors installed on the left and right of the vehicle is a summed distance of a distance from the central points of the left side mirror to the positions of driver's eyes and a distance from the central point of the right side mirror to the positions of driver's eyes.

7. A method for displaying an image of a head up display, comprising:
confirming whether a driver boards a vehicle;
confirming angles of side mirrors installed on the left and right of the vehicle if it is confirmed that the driver boards the vehicle;
estimating the positions of driver' eyes based on the angles of the left and right side mirrors;
setting display positions of image data based on the estimated positions of driver's eyes; and
outputting the image data at the set output positions.

8. The method according to claim 7, wherein in the estimating of the positions of driver's eyes, the positions of driver's eyes are estimated based on up and down and left and right angles of the left and right side mirrors.

9. The method according to claim 8, wherein the estimating of the positions of driver's eyes includes:
generating one virtual straight line which connects between central lines of the left and light side mirrors; and
calculating a vertical distance from the generated one virtual straight line to the positions of driver's eyes based on left and right rotating angles of the left and right side mirrors.

10. The method according to claim 8, wherein the estimating of the positions of driver's eyes includes:
calculating a vertical distance from central points of the left and right side mirrors to a height of the driver's eyes based on up and down rotating angles of the left and right side mirrors.
